(19) United States
(12) Patent Application Publication
(10) Pub. No.: US 2004/0069275 A1
(43) Pub. Date: Apr. 15, 2004

(54) Fuel injection device for an internal combustion engine

(76) Inventor: Marcus Parche, Korntal-Muenchingen (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/432,381

(22) PCT Filed: Jul. 13, 2002
(86) PCT No.: PCT/DE02/02576

(30) Foreign Application Priority Data
Sep. 22, 2001 (DE) 101 46 739.7

(51) Int. Cl. F02M 1/00

(52) U.S. Cl. 123/446

(57) ABSTRACT

The fuel injection system has a fuel injection valve (12) with an injection valve member (34), by which at least one injection opening (36) is controlled, and the injection valve member (34) is acted upon by the pressure prevailing in a pressure chamber (44) of the fuel injection valve (12) and is movable by this pressure counter to the force of a closing spring (40) in an opening direction to control to open the at least one injection opening (36), and fuel is delivered under high pressure to the pressure chamber (44) by a high-pressure fuel pump (10) for a fuel injection. The injection valve member (34) is urged in the closing direction at least indirectly by the a variable pressure prevailing in a control chamber (50) of the fuel injection valve (12). The pressure in the control chamber (58) is variable; the control chamber (58) has a communication with a pressure source (66; 20), which is controlled by a valve (67). Thus whereby different opening pressures of the fuel injection valve (12) for a preinjection and a main injection of fuel can be attained.

### PRIOR ART

The invention is based on a fuel injection system for an internal combustion engine as generically defined by the preamble to claim 1.

One such fuel injection system is known from German Patent Disclosure DE 42 11 651 A1. This fuel injection system has a fuel injection valve with an injection valve member, by which at least one injection opening is controlled. The injection valve member is acted upon by the pressure prevailing in a pressure chamber of the fuel injection valve and is movable by it, counter to the force of a closing spring, in an opening direction to open the at least one injection opening. Fuel is delivered under high pressure to the pressure chamber for the fuel injection. The opening pressure of the fuel injection valve, in other words the pressure in the pressure chamber, at which the pressure force acting on the injection valve member is greater than the force of the closing spring acting on the injection valve member, and at which the injection valve member moves in the opening direction to open the at least one injection opening, is dependent only on the prestressing of the closing spring and is thus fixedly specified. To adapt the fuel injection optimally to various operating states of the engine, and to adapt the course of the fuel injection for the sake of achieving the lowest possible emissions of exhaust gas and noise, however, the opening pressure of the fuel injection valve should be variable.

### ADVANTAGES OF THE INVENTION

The fuel injection system of the invention having the characteristics of claim 1 has the advantage over the prior art that by means of the variable pressure in the control chamber, the opening pressure of the fuel injection valve can be varied, making it possible to adapt to various operating states of the engine and/or to a predetermined course of the fuel injection.

In the dependent claims, advantageous features and refinements of the fuel injection system of the invention are disclosed. The embodiment according to claim 2 makes a fuel injection possible at low pressure during a preinjection, so that a small fuel quantity with little combustion noise is attained, and a fuel injection during a main injection at high pressure, thus achieving good atomization of the fuel. By the embodiment of claim 7, the pressure in the control chamber and thus the opening pressure of the fuel injection valve are controlled in a simple way. The pump work chamber can advantageously serve as the pressure source for the control chamber, as recited in claim 9, so that no additional expense is required for that purpose. The embodiment according to claim 11 enables a relief of the control chamber. The embodiment of claim 12 makes a simple variation of the pressure in the control chamber possible by relieving it with the pressure valve closed, or for the pressure furnished by the pressure source to prevail in it when the pressure valve is open.

### DRAWING

A plurality of exemplary embodiments of the invention are shown in the drawing and explained in further detail in the ensuing description.

FIG. 1 shows a fuel injection system for an internal combustion engine in a simplified illustration of a first exemplary embodiment;

FIG. 2 is a detail of the fuel injection system in a region marked II in FIG. 1;

FIG. 3 shows the course of the pressure in a fuel injection valve of the fuel injection system and a motion of its injection valve member;

FIG. 4 shows the fuel injection system in a second exemplary embodiment;

FIG. 5 shows the fuel injection system in a third exemplary embodiment;

FIG. 6 shows the fuel injection system in a fourth exemplary embodiment;

FIG. 7 shows the fuel injection system in a fifth exemplary embodiment; and

FIG. 8 shows the fuel injection system in a sixth exemplary embodiment.

### DESCRIPTION OF THE EXEMPLARY EMBODIMENTS

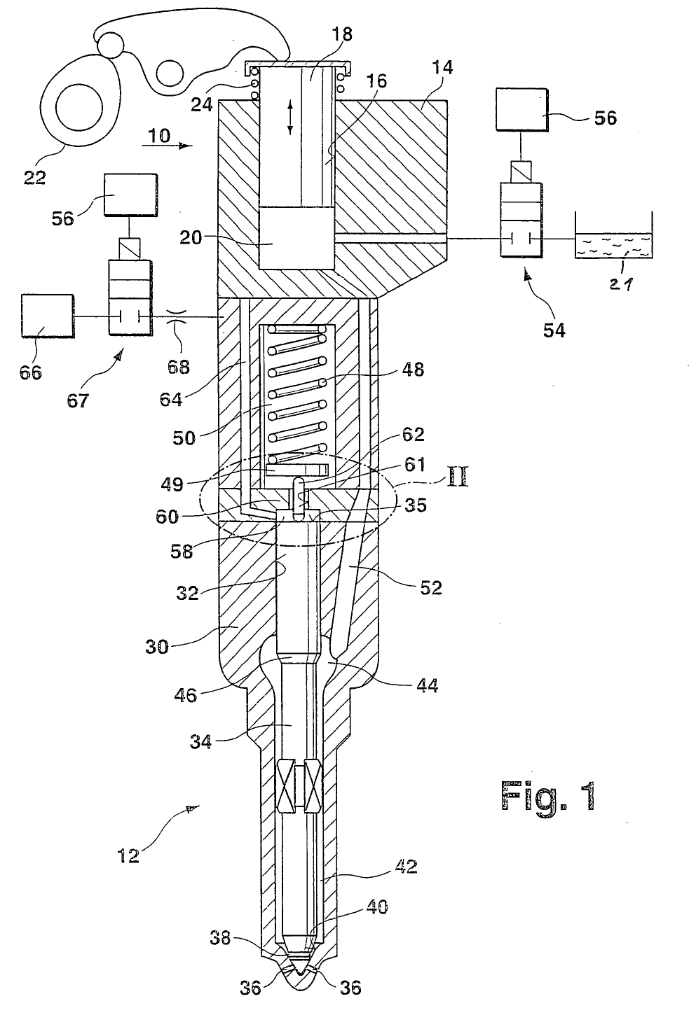

In FIGS. 1, 2 and 4-8, a fuel injection system for an internal combustion engine, for instance of a motor vehicle, is shown. The engine is a self-igniting internal combustion engine and has one or more cylinders. In the exemplary embodiment shown in FIG. 1, the fuel injection system is embodied as a unit fuel injector, and for each cylinder of the engine, it has one high-pressure fuel pump 10 and one fuel injection valve 12, which form a common structural unit. In a departure from this, however, it can also be provided that the high-pressure fuel pump and the fuel injection valve 12 are disposed separately from one another and communicate with one another via a line. It can also be provided that one common high-pressure fuel pump is provided for all the cylinders of the engine, while each cylinder is provided with its own fuel injection valve 12.

The high-pressure fuel pump 10 has a pump body 14, in which a pump piston 18 is guided sealingly displaceably in a cylinder bore 16 and defines a pump work chamber 20 in the cylinder bore 16. The pump piston 18 is driven in a reciprocating motion by a cam 22 of a camshaft of the engine, counter to the force of a restoring spring 24.

The fuel injection valve 12 has a valve body 30, which may be embodied in multiple parts and which is connected to the pump body 14. In the valve body 30, there is a bore 32 in which an injection valve member 34 is guided longitudinally displaceably. The valve body 30, in its end region toward the combustion chamber of the cylinder of the engine, has at least one and preferably a plurality of injection openings 36. The injection valve member 34, in its end region toward the combustion chamber, has a sealing face 38, which for instance is approximately conical and which cooperates with a valve seat 40, embodied in the valve body 30 in its end region toward the combustion chamber; the injection openings 36 lead away from or downstream of this valve seat. In the valve body 30, between the injection valve member 34 and the bore 32, toward the valve seat 40, there is an annular chamber 42, which in its end region remote from the valve seat 40 changes over, by means of a radial widening of the bore 32, into a pressure chamber 44 that surrounds the injection valve member 34. At the level of the pressure chamber 44, the injection valve member 34 has a pressure shoulder 46, created by a cross-sectional reduction. The end of the injection valve member 34 remote from the combustion chamber is engaged at least indirectly by a prestressed closing spring 48, by which the injection valve member 34 is pressed toward the valve seat 40. The closing spring 48 is disposed in a spring chamber 50 of the valve body 30 that adjoins the bore 32. A conduit 52 is embodied in the pump body 14 and in the valve body 30, and through it the pressure chamber 44 communicates with the pump work chamber 20.

The pump work chamber 20 has a communication with a low-pressure region, for instance at least indirectly with a fuel tank 21, which is controlled by an electrically controlled valve 54. The valve 54 may be embodied as a magnet valve or may have a piezoelectric actuator and is triggered by an electronic control unit 56. In an intake stroke of the pump piston 18, the valve 54 is opened, so that fuel from the fuel tank 21 can reach the pump work chamber 20. In the pumping stroke of the pump piston 18, the valve 54 is closed by the control unit 56, at an instant at which a fuel injection is to begin. The length of time for which the valve 54 remains closed determines the quantity of fuel that is injected.

The injection valve member 34, with its end face 35 remote from the combustion chamber, defines a control chamber 58 in the bore 32, toward the spring chamber 50. It can also be provided that the control chamber 58 is defined by a separate piston, which is braced on the injection valve member 34. Between the control chamber 58 and the spring chamber 50, a partition 60 is provided, in which a bore 61 is embodied through which a bolt 62 passes; this bolt has a smaller diameter than the injection valve member 34. The bolt 62 rests on one end on the end face 35 of the injection valve member 34 and on the other, in the spring chamber 50, on a spring plate 49, which in turn rests on the closing spring 48. The bolt 62 passes with slight radial play through the bore 61, thus separating the control chamber 58 from the spring chamber 50. A variable pressure is set in the control chamber 58, and several exemplary embodiments of this will now be described.

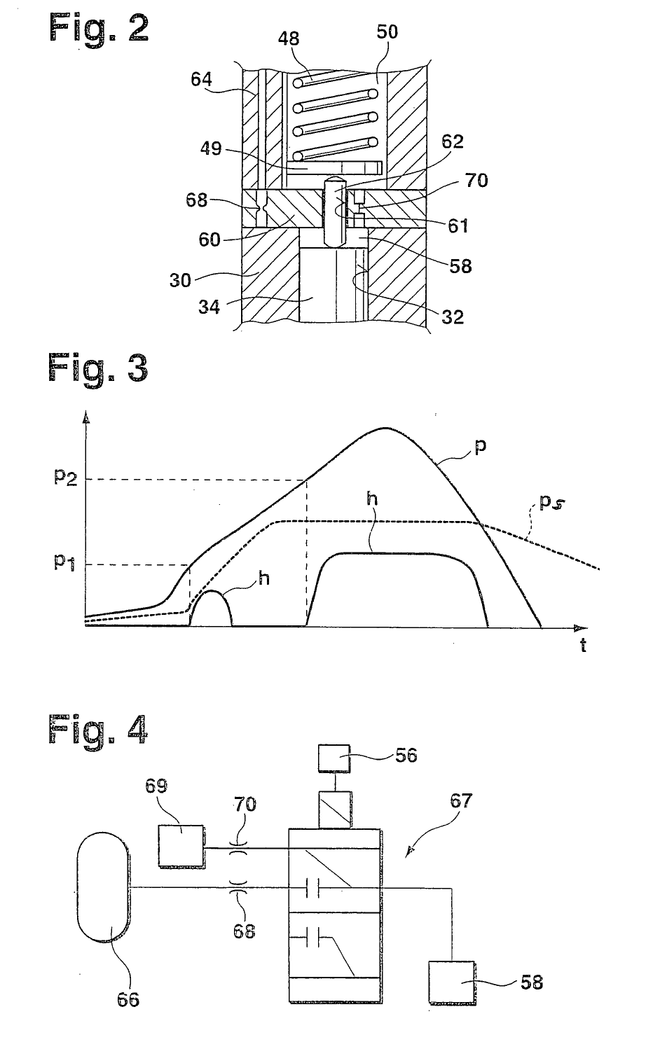

In a first exemplary embodiment, shown in FIG. 1, a conduit 64 that discharges into the control chamber 58 is embodied in the valve body 30 and/or in the pump body 14. Via the conduit 64, the control chamber 58 communicates with an external pressure source 66, which can for instance be a pressure reservoir, or a pressure generator in the form of a pump. The communication of the control chamber 58 with the pressure source 66 is controlled by a final control element 67, which is for instance an electrically controlled valve and which can be embodied as a magnet valve and is triggered by the control unit 56. In the first exemplary embodiment shown, the valve 67 is embodied as a 2/2-way valve, by which in a first switching position the control chamber 58 is made to communicate with the pressure source 66 and by which in a second switching position the control chamber 58 is disconnected from the pressure source 66. At least one throttle restriction 68 can be provided in the communication of the control chamber 58 with the pressure source 66. When the control chamber 58 communicates with the pressure source 66, an elevated pressure prevails in it, and this pressure acts on the end face 35 of the injection valve member 34 and generates an additional force, reinforcing the force of the closing spring 48, on the injection valve member 34 in its closing direction toward the valve seat 40. When the control chamber 58 is disconnected from the pressure source 66, the elevated pressure in the control chamber 58 decreases, via the play existing between the bolt 62 and the bore 61, into the spring chamber 50 that communicates with a low-pressure region. Alternatively, as shown in FIG. 2, the control chamber 58 can communicate with the spring chamber 50 via a throttle bore in the partition 60, and via the spring chamber it can communicate with the low-pressure region. The throttle restriction 68 in the communication of the control chamber 58 with the pressure source 66 can likewise be embodied as a throttle bore in the valve body 30.

In FIG. 3, the course of the pressure p, generated in its reciprocating motion in the pumping stroke in the pump work chamber as well as in the pressure chamber 44, the pressure ps set in the control chamber 58, and the reciprocating motion h of the injection valve member 34 of the fuel injection valve 12 is over time during one injection cycle. When the fuel injection is to begin, the valve 54 is closed by the control unit 56, and the valve 67 is likewise closed. Thus a low pressure prevails in the control chamber 58, and essentially only the force of the closing spring 48 acts on the injection valve member 34. When the pressure prevailing in the pressure chamber 44, via the pressure shoulder 46, generates a force on the injection valve member 34 in its opening direction away from the valve seat 40, which force is greater than the force of the closing spring 48, then the fuel injection valve 12 opens. The injection valve member 34 lifts with its sealing face 38 from the valve seat 40 and opens the injection openings 36, through which fuel is injected. The fuel injection takes place at relatively low pressure and in a lesser quantity than a fuel preinjection. The pressure in the pressure chamber 44 at which the fuel injection valve 12 opens is called the opening pressure. For terminating the preinjection of fuel, the valve 67 is opened by the control unit 56, so that the control chamber 58 communicates with the pressure source 66, and in it, an elevated pressure is set, corresponding to the pressure furnished by the pressure source 66. The closing force acting on the injection valve member 34 is thus increased, so that the fuel injection valve 12 closes again because the injection valve member 34 comes to rest with its sealing face 38 on the valve seat 40. After that, the pressure in the pressure chamber 44 rises in accordance with the profile of the cam 22 that drives the pump piston 18, that an increasing pressure force in the opening direction acts on the injection valve member 34. When the opening pressure generated by the pressure prevailing in the pressure chamber 44 on the injection valve member 34 exceeds the closing force, which is, a total of the force of the closing spring 48 and the pressure force generated by the pressure in the control chamber 58, the fuel injection valve 12 opens again. The main injection that then ensues takes place at a higher pressure than the preinjection and for a longer length of time. The opening pressure p₂ of the fuel injection valve 12 in the main injection is thus higher than the opening pressure p₁ in the. preinjection. Upon termination of the main injection, the valve 54 is opened, so that the pressure chamber 44 is relieved. The valve 67 is opened as well, so that the control chamber 58 is likewise relieved. In an ensuing injection cycle, a low pressure again prevails then in the control chamber 58, so that for the preinjection, the low opening pressure p₁ is available at the fuel injection valve.

In FIG. 4, the fuel injection system is shown in simplified form in a second exemplary embodiment, in which compared to the first exemplary embodiment the embodiment of the final control element 67 is modified. The final control element 67 is embodied as a 3/2-way valve, which has three connections and two switching positions and is triggered by the control unit. In a first switching position of the valve 67, this valve causes the control chamber 58 to communicate with the pressure source 66 and disconnects it from a low-pressure region 69, and in a second switching position, the control chamber 58 is disconnected from the pressure source 66 and communicates with the low-pressure region 69. A relief of the control chamber 58 is thus likewise controlled by the valve 67. At least one throttle restriction 70 may be provided in the communication of the control chamber 58 with the low-pressure region 69.

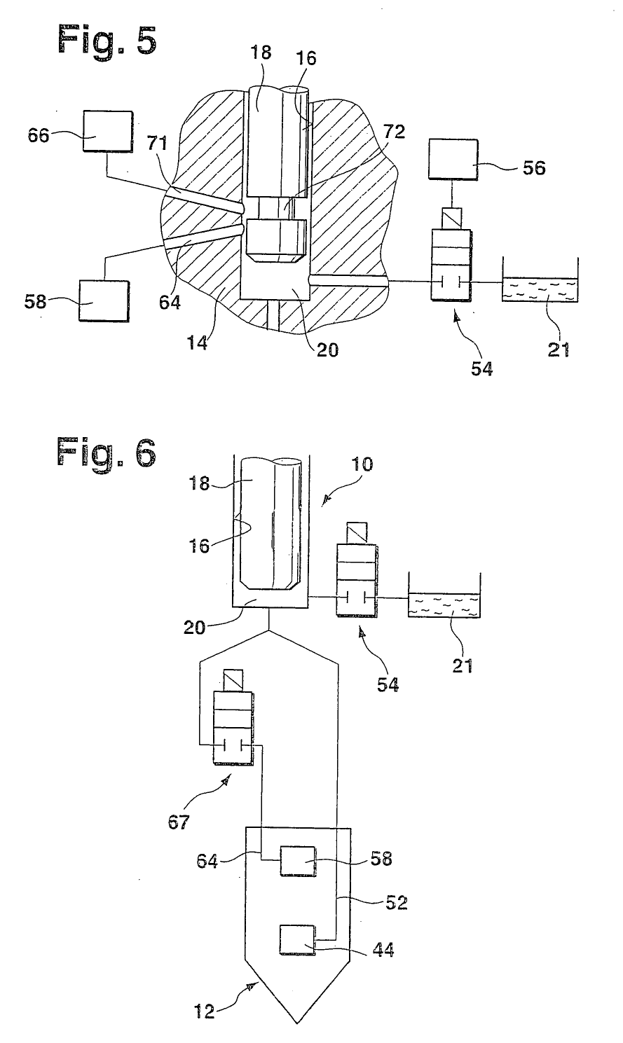

In FIG. 5, the fuel injection system is shown in simplified form in a third exemplary embodiment. Here the pump piston 18 acts as the final control element by which the communication of the control chamber 58 with the pressure source 66 is controlled. Both a conduit 71 leading to the pressure source 66 and the conduit 64, spaced axially apart from that conduit, leading to the control chamber 58 discharge into the cylinder bore 16. The pump piston 18 has a plunge cut 72 of reduced cross section that extends over a predetermined width in the axial direction. At the onset of the pumping stroke of the pump piston 18 inward into the cylinder bore 16, the pump piston is located with its full cross section in the region of the orifice of the conduit 71, so that this conduit is closed, and the control chamber 58 is disconnected from the pressure source 66. When the pump piston 18 in its pumping stroke moves farther into the cylinder bore 16, its plunge cut 72 comes to overlap the orifice of the conduit 71, so that the conduit 64 and thus the control chamber 58 communicate with the pressure source 66 via the plunge cut 72. At the onset of the pumping stroke of the pump piston 18, a low pressure thus prevails in the control chamber 58, and so the low opening pressure for the preinjection is achieved, and as the pumping stroke of the pump piston 18 continues, the pressure in the control chamber 58 is raised, so that the higher opening pressure for the main injection is reached.

In FIG. 6, the fuel injection system is shown in simplified form in a fourth exemplary embodiment, in which unlike the exemplary embodiments described above there is no external pressure source; instead, the pump work chamber 20 is used as a pressure source for increasing the pressure in the control chamber 58. The control chamber 58 has a communication with the pump work chamber 20 that is controlled by a final control element 67. In the exemplary embodiment shown in FIG. 5, the final control element is embodied as a 2/2-way valve 67, by which the control chamber 58 communicates with the pump work chamber 20 in a first switching position and is disconnected from the pump work chamber 20 in a second switching position. Alternatively, the final control element 67 can be embodied as in the second exemplary embodiment as a 3/2-way valve, by which in a first switching position the control chamber 58 communicates with the pump work chamber 20 and is disconnected from a low-pressure region 69, and in a second switching position the control chamber 58 is disconnected from the pump work chamber and communicates with the low-pressure region 69.

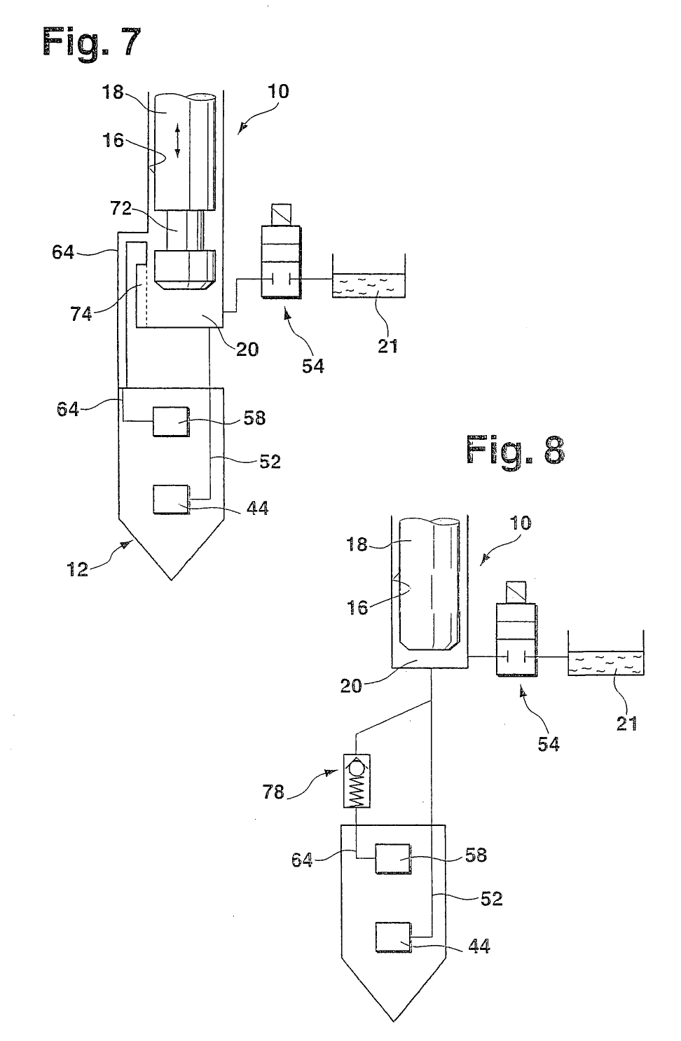

In FIG. 7, the fuel injection system is shown in simplified form in a fifth exemplary embodiment, in which once again the pump work chamber 20 serves as a pressure source for the control chamber 58. The communication of the control chamber 58 with the pump work chamber 20 is controlled by the pump piston 18 acting as a final control element. From the circumference of the cylinder bore 16, a conduit 64 leads to the control chamber 58. The pump piston 18 has a plunge cut 72 of reduced cross section that extends over a predetermined width in the axial direction. The cylinder bore 16, in its inner end region over at least part of its circumference, has a radial enlargement 74, for instance in the form of a groove. At the onset of the pumping stroke of the pump piston 18 into the cylinder bore 16, the pump piston is located with its full cross section in the region between the orifice of the conduit 64 and the enlargement 74 of the cylinder bore 16, so that the conduit 64 and thus the control chamber 58 are disconnected from the pump work chamber 20. When the pump piston 18 in its pumping stroke moves onward into the cylinder bore 16, its plunge cut 72 comes to coincide with the enlargement 74 of the cylinder bore 16, so that the conduit 64 and thus the control chamber 58 communicate with the pump work chamber 20 via the plunge cut 72. Thus at the onset of the pumping stroke of the pump piston 18, a low pressure prevails in the control chamber 58, so that the low opening pressure for the preinjection is reached, and as the pumping stroke of the pump piston 18 continues, the pressure in the control chamber 58 is raised, so that the higher opening pressure for the main injection is reached.

In FIG. 8, the fuel injection system is shown in simplified form in a sixth exemplary embodiment, in which once again the pump work chamber 20 acts as a pressure source for the control chamber 58. The control chamber 58 has a communication with the pump work chamber 20, in which as a final control element a pressure valve 78 is disposed that opens toward the control chamber 58. When the pressure in the pump work chamber 20 is less than the opening pressure of the pressure valve 78, the pressure valve is closed and the control chamber 58 is disconnected from the pump work chamber 20. The control chamber 58 is then relieved to a low-pressure region. When the pressure of the pump work chamber 20 exceeds the opening pressure of the pressure valve 78, the pressure valve opens, and the control chamber 58 communicates with the pump work chamber 20. The opening pressure of the pressure valve 78 is set such that this valve closes when the pumping stroke is short and the pressure in the pump work chamber 20 is thus low, so that a low pressure prevails in the control chamber 58, and a low opening pressure of the fuel injection valve 12 for the preinjection is reached. As the pumping stroke lengthens and the pressure in the pump work chamber 20 thus rises, the pressure valve 78 opens, so that the control chamber 58 communicates with the pump work chamber 20, and a higher opening pressure of the fuel injection valve 12 for the main injection is reached.

1. A fuel injection system for an internal combustion engine, having a fuel injection valve (12), which has an injection valve member (34), by which at least one injection opening (36) is controlled, and the injection valve member (34) is acted upon by the pressure prevailing in a pressure chamber (44) of the fuel injection valve (12) and is movable by this pressure counter to the force of a closing spring (48) in an opening direction to open the at least one injection opening (36), and fuel is delivered under high pressure to the pressure chamber (44) by a high-pressure fuel pump (10) for a fuel injection, characterized in that the injection valve member (34) is urged in the closing direction at least indirectly by the pressure prevailing in a control chamber (58) of the fuel injection valve (12); and that the pressure in the control chamber (58) is variable.

2. The fuel injection system of claim 1, characterized in that during one fuel injection cycle, at the onset, for a preinjection of fuel in the control chamber (58), a low pressure is set; and that for an ensuing main injection of fuel in the control chamber (58), an elevated pressure is set.

3. The fuel injection system of claim 1 or 2, characterized in that the control chamber (58) has a communication with a pressure source (66; 20), which is controlled by a valve (67).

4. The fuel injection system of claim 3, characterized in that the valve is an electrically controlled valve (67).

5. The fuel injection system of claim 4, characterized in that the valve (67) is a 2/2-way valve, by which in a first switching position the control chamber (58) is made to communicate with the pressure source (66; 20), and by which in a second switching position the control chamber (58) is disconnected from the pressure source (66; 20).

6. The fuel injection system of claim 4, characterized in that the valve (67) is a 3/2-way valve, by which in a first switching position the control chamber (58) is made to communicate with the pressure source (66; 20), and is disconnected from a low-pressure region (69) and by which in a second switching position the control chamber (58) is disconnected from the pressure source (66; 20) and is made to communicate with the low-pressure region (69).

7. The fuel injection system of claim 1 or 2, characterized in that the control chamber (58) has a communication with a pressure source (66; 20); that the high-pressure fuel pump (10) has a pump piston (18), which is driven in a reciprocating motion; and that by means of the pump piston (18), as a function of its pumping stroke, the communication of the control chamber (58) with the pressure source (66; 20) is controlled.

8. The fuel injection system of claim 7, characterized in that the control chamber (58), at a short pumping stroke of the pump piston (18), is disconnected from the pressure source (66; 20), and at a longer pumping stroke of the pump piston (18) is made to communicate with the pressure source (66; 20).

9. The fuel injection system of one of the foregoing claims, characterized in that the high-pressure fuel pump (10) has a pump piston (18), which is driven in a reciprocating motion and defines a pump work chamber (20); and that the pump work chamber (20) serves as the pressure source for the control chamber (58).

10. The fuel injection system of one of claims 3-9, characterized in that at least one throttle restriction (68) is provided in the communication of the control chamber (58) with the pressure source (66; 20).

11. The fuel injection system of one of the foregoing claims, characterized in that the control chamber (58) has a communication with a low-pressure region (69), in which at least one throttle restriction (70) is provided.

12. The fuel injection system of one of claims 1, 2, 10 or 11, characterized in that the control chamber (58) has a communication with a pressure source (66; 20), in which a pressure valve (78) opening toward the control chamber (58) is disposed, which pressure valve, when a predetermined pressure is exceeded, opens the communication of the control chamber (58) with the pressure source (66; 20).

13. The fuel injection system of one of the foregoing claims, characterized in that this system has one fuel injection valve (12) and one high-pressure fuel pump (10), which form a common structural unit, for each cylinder of the engine.
